(19) United States
(12) Patent Application Publication
(10) Pub. No.: US 2026/0316567 A1
(43) Pub. Date: Oct. 15, 2026

(54) CONTROL DEVICE, CONTROL METHOD, AND STORAGE MEDIUM

(71) Applicant: HONDA MOTOR CO., LTD., Tokyo (JP)

(72) Inventors: Akiko SATO, Tokyo (JP); Mitzuki Owada, Tokyo (JP); Yusei Fujinaga, Tokyo (JP)

(73) Assignee: HONDA MOTOR CO., LTD., Tokyo (JP)

(21) Appl. No.: 19/467,861

(22) Filed: Feb. 3, 2026

(30) Foreign Application Priority Data
Feb. 5, 2025 (JP) 2025-017931

(51) Int. Cl. B60K 35/28; B60W 30/06; G06T 5/50

(52) U.S. Cl. CPC B60K 35/285; B60W 30/06; G06T 5/50

(57) ABSTRACT

A control device includes a processor which is configured to acquire a captured image using an imaging device provided in a vehicle, and display a composite image of a current peripheral image of the vehicle and a blind spot image of the vehicle on a display. The current peripheral image is based on the captured image acquired by the processor. The blind spot image is based on the captured image acquired by the processor in the past. The processor is further configured to perform control to change visibility of a portion corresponding to the blind spot image in the composite image based on a vehicle speed of the vehicle, and display the portion corresponding to the blind spot image in the composite image even when the vehicle is in a stopped state.

### CROSS-REFERENCE TO RELATED APPLICATIONS

This application is based on and claims priority under 35 USC 119 from Japanese Patent Application No. 2025-017931 filed on Feb. 5, 2025, the entire content of which is incorporated herein by reference.

### TECHNICAL FIELD

The present disclosure relates to a control device, a control method, and a non-transitory computer-readable storage medium.

### BACKGROUND ART

In recent years, active efforts have been made to provide access to a sustainable transportation system in consideration of vulnerable people among traffic participants. In order to implement the above, focus has been placed on research and development on further improving safety and convenience of traffic by research and development related to driving assistance techniques.

For example, as a parking assistance function of parking a vehicle to a predetermined position, there is a function of displaying a ground view or a multi-view of a vehicle or a situation near the vehicle at a viewing angle of looking down the own vehicle by placing a viewpoint directly above the own vehicle when searching for a target parking position. In this function, images acquired by a plurality of cameras are combined and displayed as one image. However, in this case, it is difficult to capture an image of a partial region immediately below or near the vehicle in real time due to an arrangement of the cameras. Therefore, in order to display such a blind spot region as an image, a technique has been proposed in which an image captured during traveling a predetermined time before is combined with a ground view image and displayed to show a lower side of the vehicle transparently.

Patent Literature JP2023-023873A describes a camera which takes images of a view around an own vehicle and a vehicle surroundings monitoring device which stores the images of the view around the own vehicle taken by the camera, produces a current image under a floor of the own vehicle as an underfloor image by using the stored images, displays the produced underfloor image on a display, terminates displaying the underfloor image on the display when time for which the own vehicle has stopped reaches a predetermined first time, and, for example, displays another image that is different from the underfloor image such as an icon.

### SUMMARY OF INVENTION

However, the transparent image under the vehicle through the floor of the vehicle, which is produced when the vehicle is stopped, is not a real-time image at the time, but a past image while the vehicle was moving. Therefore, a driver may misidentify condition under the own vehicle’s floor (a region that is a blind spot) when viewing the displayed image. According to Patent Literature JP2023-023873A, in order to prevent misidentification of condition of the underfloor, another image is displayed in place of the underfloor image after a predetermined time from when the vehicle is stopped, but there is room for improvement in a display mode of the image for preventing the misidentification.

Aspects of non-limiting embodiments of the present disclosure relate to providing a control device, a control method, and a non-transitory computer-readable storage medium storing a control program capable of appropriately displaying a blind spot region of a vehicle. This hence contributes to development of a sustainable transportation system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device including a processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past, in which the processor is further configured to perform control to change visibility of a portion corresponding to the blind spot image in the composite image based on a vehicle speed of the vehicle, and display the portion corresponding to the blind spot image in the composite image even when the vehicle is in a stopped state.

According to an aspect of the present disclosure, there is provided a control method for a control device including a processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past, the control method including performing control to change visibility of a portion corresponding to the blind spot image in the composite image based on a vehicle speed of the vehicle, and displaying the portion corresponding to the blind spot image in the composite image even when the vehicle is in a stopped state.

A non-transitory computer-readable storage medium storing a control program causing a processor of a control device to perform processing, the processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past, the processing including performing control to change visibility of a portion corresponding to the blind spot image in the composite image based on a vehicle speed of the vehicle, and displaying the portion corresponding to the blind spot image in the composite image even when the vehicle is in a stopped state.

According to an aspect of the present disclosure, there is provided a control device, a control method, and a non-transitory computer-readable storage medium storing a control program capable of appropriately displaying a blind spot region of the vehicle.

### BRIEF DESCRIPTION OF DRAWINGS

Exemplary embodiment(s) of the present invention will be described in detail based on the following figures, wherein:

FIG. 1 is a side view of a vehicle 1 in which a control device according to the present embodiment is installed;

FIG. 2 is a top view of the vehicle 1 shown in FIG. 1;

FIG. 3 is a block diagram showing an example of an internal configuration of the vehicle 1 shown in FIG. 1;

FIG. 4 is a diagram showing an example of an image displayed on a touch panel 22 of the vehicle 1;

FIG. 5 is a diagram showing an example of a composite image;

FIG. 6 is a flowchart showing an example of a display process of the composite image performed by a control device 30;

FIG. 7 shows a first example of association information;

FIG. 8 shows a second example of the association information;

FIG. 9 shows a third example of the association information;

FIG. 10 shows a fourth example of the association information;

FIG. 11 shows a fifth example of the association information;

FIG. 12 is a diagram illustrating an example of display control on the composite image when the vehicle 1 automatically parks to a target parking position 231;

FIG. 13 is a diagram showing an example for a comparison of the composite image based on a difference in transmittance of a mask image 224; and

FIG. 14 is a diagram showing an example of a state where a blind spot image of the vehicle 1 includes a region having a contrast.

### DESCRIPTION OF EMBODIMENTS

Hereinafter, an embodiment of a control device, a control method, and a non-transitory computer-readable storage medium of the present disclosure will be described with reference to the drawings. The drawings are viewed in directions of reference numerals. The following embodiment does not limit the present invention, and not all of elements described in the following embodiment are necessary for the present invention. Hereinafter, the same or similar elements are denoted by the same or similar reference signs, and the description thereof may be omitted or simplified.

### 1. Vehicle

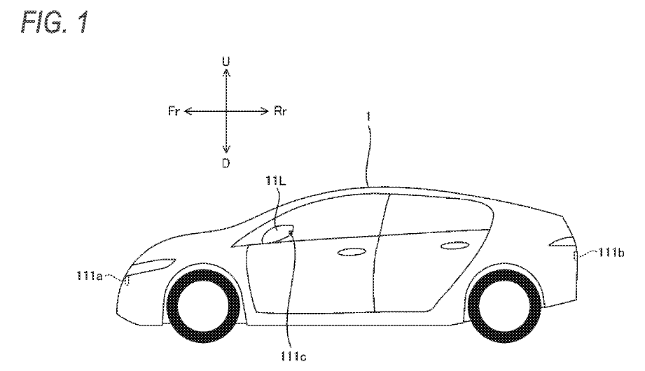

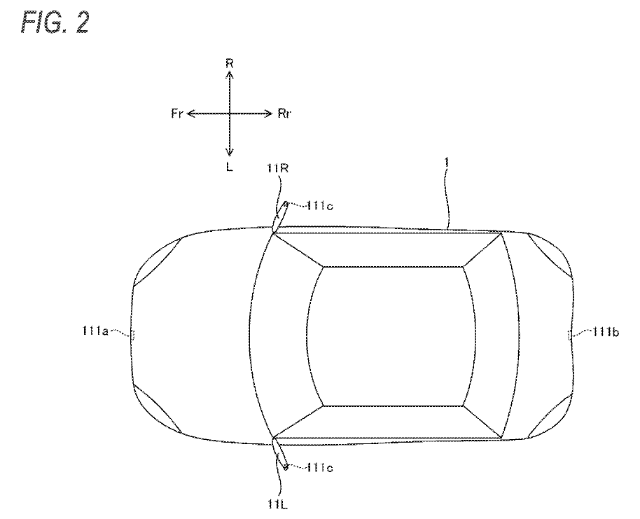

FIG. 1 is a side view of a vehicle 1 in which a control device according to the present embodiment is installed. FIG. 2 is a top view of the vehicle 1 shown in FIG. 1. The vehicle 1 according to the present embodiment is an automobile including a drive source (not shown), and wheels (not shown) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 further includes side mirrors 11L and 11R. The side mirrors 11L and 11R are mirrors (back mirrors) provided on outer sides of front seat doors of the vehicle 1 for a driver to check a rear side and rear lateral sides. The side mirrors 11L and 11R are fixed to a main body of the vehicle 1 by rotation shafts extending in a vertical direction, and can be opened and closed by rotating about the rotation shafts.

The vehicle 1 further includes a front camera 111a, a rear camera 111b, and side cameras 111c. The front camera 111a is a digital camera that is provided on a front side of the vehicle 1 and images the front side of the vehicle 1. The rear camera 111b is a digital camera that is provided on a rear side of the vehicle 1 and images the rear side of the vehicle 1. The side cameras 111c are digital cameras that are respectively provided on the left and right side mirrors 11L and 11R of the vehicle 1 and images a left or right side of the vehicle 1.

### 2. Internal Configuration of Vehicle

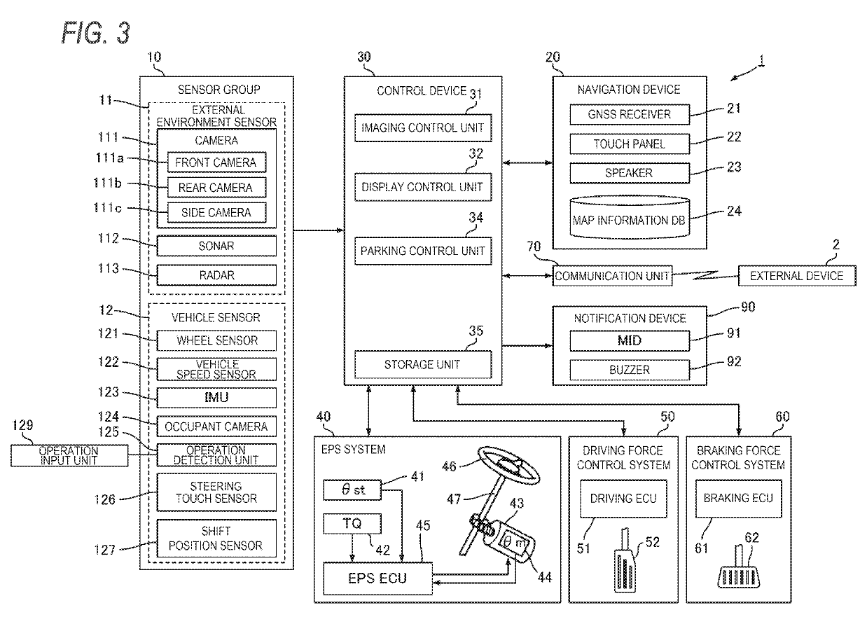

FIG. 3 is a block diagram showing an example of an internal configuration of the vehicle 1 shown in FIG. 1. The vehicle 1 includes a sensor group 10, a navigation device 20, a control device 30, an electric power steering (EPS) system 40, a driving force control system 50, a braking force control system 60, a communication unit 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as "vehicle information"). The information acquired by each sensor in the sensor group 10 is output to the control device 30, and is used for control of the vehicle 1 (hereinafter, also referred to as "vehicle control") performed by the control device 30.

The external environment sensor 11 includes, for example, cameras 111, a sonar 112, and a radar 113. The cameras 111 image the periphery of the vehicle 1 including the front side of the vehicle 1, and output image data of an obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front windshield or a front grille (not shown) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on the left and right side mirrors 11L and 11R, and image scenes on lateral sides (that is, the left and right sides) of the vehicle 1. The peripheral images of the vehicle 1 captured by the front camera 111a, the rear camera 111b, the side camera 111c on the left side, and the side camera 111c on the right side are also referred to as a front image, a rear image, a left side image, and a right side image, respectively. An image constituted by the left side image and the right side image may be referred to as a lateral side image. The peripheral image of the vehicle 1 generated by combining the imaging data of the front camera 111a, the rear camera 111b, and the left and right side cameras 111c may be referred to as an overhead image.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called "driver monitor camera" provided to be able to image a head of an occupant seated in a driver seat of the vehicle 1 (for example, a user driving the vehicle 1, hereinafter simply referred to as "user") from the front. As the occupant camera 124, a digital camera using an imaging element such as the CCD or the CMOS can be adopted, similarly to the camera 111.

The operation detection unit 125 detects an operation performed by using an operation input unit 129 that is operable by the user. The operation input unit 129 may include, for example, a switch or a button that receives a command related to parking assistance to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not shown) provided in the vehicle 1 is any one of "P (parking)", "R (reverse)", "N (neutral)", and "D (drive)". When the vehicle 1 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as "paths"). Each of the nodes in the road network information represents, for example, a feature of a corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a travel direction, a road type, and the like is set.

The GNSS receiver 21 specifies a current position of the vehicle 1 (for example, a latitude and a longitude of a location where the vehicle 1 is located) based on a signal received from a GNSS satellite. In addition, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output a sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30.

For example, the navigation device 20 may cause, according to the instruction from the control device 30, the touch panel 22 to display an operation button for receiving a command request related to parking assistance. Further, the navigation device 20 may output, to the control device 30, operation information of the command request related to the parking assistance received via the touch panel 22. The "parking assistance" means assistance for parking the vehicle 1 to a predetermined parking position.

Specifically, the navigation device 20 causes the touch panel 22 to display a parking assistance button for requesting the parking assistance of the vehicle 1. The parking assistance button includes an automatic parking button for requesting parking that is based on automatic steering of the control device 30, and a parking support button for requesting support during parking of the vehicle 1 that is based on an operation of the driver. When the parking assistance button is operated via the touch panel 22, the navigation device 20 outputs operation information to the control device 30.

The navigation device 20 causes the touch panel 22 to display the overhead image in which the vehicle 1 and the periphery of the vehicle 1 are overlooked. Further, the navigation device 20 causes the touch panel 22 to display a three-dimensional (3D) image in which the peripheral image of the vehicle 1 and an image of the vehicle 1 are superimposed. Although the touch panel 22 of the navigation device 20 is used as an input device or a display device in the present example, for example, a head-up display (HUD), a smartphone, a tablet terminal, or the like may be used.

The “parking” is, for example, a stop as the occupant gets on and off the vehicle, and excludes a temporary stop due to a traffic signal or the like. Further, the "parking position" means a position where the vehicle 1 is to be stopped, that is, a position to be parked to.

The control device 30 is an example of the control device according to the present embodiment and is a computer that integrally controls the entire vehicle 1. For example, the control device 30 includes a processor (not shown) that performs various calculations, a storage unit 35 including a non-transitory storage medium that stores various types of information (for example, programs and various types of data), and an input and output unit (not shown) as an interface that controls input and output of data between the inside and the outside of the control device 30.

The control device 30 includes, for example, an imaging control unit 31, a display control unit 32, and a parking control unit 34 as functional units implemented by the processor executing the programs stored in the storage unit 35. These functional units will be described later, and thus the description thereof will be omitted here. For example, the control device 30 is implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 1, based on an operation on an accelerator pedal 52 provided in the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under the control of the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

Next, each functional unit of the control device 30 will be described in detail. For example, the imaging control unit 31 acquires a captured image using an imaging device provided in the vehicle 1. The "imaging device" is, for example, the front camera 111a, the rear camera 111b, and the side cameras 111c.

The parking control unit 34 performs automatic parking for automatically moving the vehicle 1 from a present location to a target parking position.

The display control unit 32 displays, on a display, a composite image of a current peripheral image of the vehicle 1 based on the captured image acquired by the imaging control unit 31 and a blind spot image of the vehicle 1 based on the captured image acquired in the past by the imaging control unit 31. The "peripheral image" is, for example, an image of the front, rear, left, and right sides of the vehicle 1. The "blind spot image" is an image of a region that is a blind spot around the vehicle 1, for example, an image under the vehicle 1 (underfloor). The "captured image acquired" is an image acquired by latest imaging, that is, a real-time image (with some delay). The "captured image acquired in the past" is an image acquired by imaging before the image acquired by the latest imaging, for example, immediately before the vehicle enters a current blind spot region (underfloor). The composite image is displayed as, for example, the overhead image or the 3D image. The "display" is, for example, the touch panel 22.

The display control unit 32 performs control to change visibility of a portion corresponding to the blind spot image in the composite image, based on the vehicle speed of the vehicle 1. Further, the display control unit 32 performs control to display the portion corresponding to the blind spot image in the composite image even in a stopped state of the vehicle 1. The "change visibility of a portion corresponding to the blind spot image in the composite image, based on the vehicle speed of the vehicle 1" means to decrease the visibility of the portion corresponding to the blind spot image as the vehicle speed decreases. The "display the portion corresponding to the blind spot image" means that the blind spot image is not completely invisible even when the vehicle speed is 0 km/h. The display control unit 32 displays, for example, the portion corresponding to the blind spot image at a transmittance of 90 % in the stopped state of the vehicle 1. The display control unit 32 may superimpose, for example, a mask image having a transmittance of 10 % on the blind spot image in the stopped state of the vehicle 1.

The display control unit 32 decreases the visibility of the portion corresponding to the blind spot image in the composite image as the vehicle speed of the vehicle 1 decreases. The "decrease the visibility" means performing such image processing that makes it difficult to visually recognize a state of the blind spot region represented by the blind spot image. For example, the "decrease the visibility" means increasing transmittance of the blind spot image. In another example, the "decrease the visibility" means decreasing the transmittance of the mask image superimposed on the blind spot image. In another example, "decrease the visibility" may mean increasing a degree of mosaic processing (for example, increasing a block size of a pixel), or may mean increasing a degree of blurring processing (for example, increasing a radius or intensity of a blurring filter). A change in the visibility may mean, for example, changes in the visibility in two stages including a low speed stage and a high speed stage. The visibility may be more finely changed without being limited to two stages.

In a state where the vehicle 1 is moved by a driving operation (manual driving operation) of the user, when an instruction operation for displaying the composite image from the user is received, the display control unit 32 performs control to display the composite image on the display and change the visibility of the portion corresponding to the blind spot image based on the vehicle speed. The "instruction operation" includes, for example, an operation on the touch panel 22, a button operation, a voice input, and the like for displaying the composite image.

When the automatic parking based on the parking control unit 34 is started in a state where the vehicle 1 is moved by the automatic parking, the display control unit 32 performs control to display the composite image on the display and change the visibility of the portion corresponding to the blind spot image based on the vehicle speed.

When a turning point is present on a route from the present location to the target parking position, the display control unit 32 prevents the control for changing the visibility of the portion corresponding to the blind spot image based on the vehicle speed, until the vehicle 1 performs a predetermined travel after passing through the turning point. The "predetermined travel" is a travel for a predetermined time or a travel for a predetermined distance. The "prevent the control for changing the visibility" means preventing the control for decreasing the visibility as compared with a case where there is no turning point. The control may be prevented by, for example, not controlling the visibility or fixing the visibility. A travel at the turning point will be described later with reference to FIG. 12.

When a shift state of the vehicle 1 is parking, the display control unit 32 performs control to hide the portion corresponding to the blind spot image in the composite image and display only the peripheral image. The "hide the portion of the blind spot image" means, for example, setting the transmittance of the blind spot image to 100 %. The "hide the portion of the blind spot image" may mean that the transmittance of the superimposed mask image is set to 0 %. The "hide the portion of the blind spot image" may mean that a state of the blind spot region cannot be recognized by the mosaic processing or the blurring processing. The "when ... is parking" means a state where the vehicle 1 is stopped and a state where the blind spot image is not updated.

When the shift state of the vehicle 1 is parking, the display control unit 32 performs control to replace the portion corresponding to the blind spot image in the composite image with a predetermined image. The "predetermined image" is an alternative image which is, for example, a uniform image, such as a black image, or a pattern image. Specifically, the display control unit 32 performs control to combine the peripheral image and the predetermined image to generate the composite image.

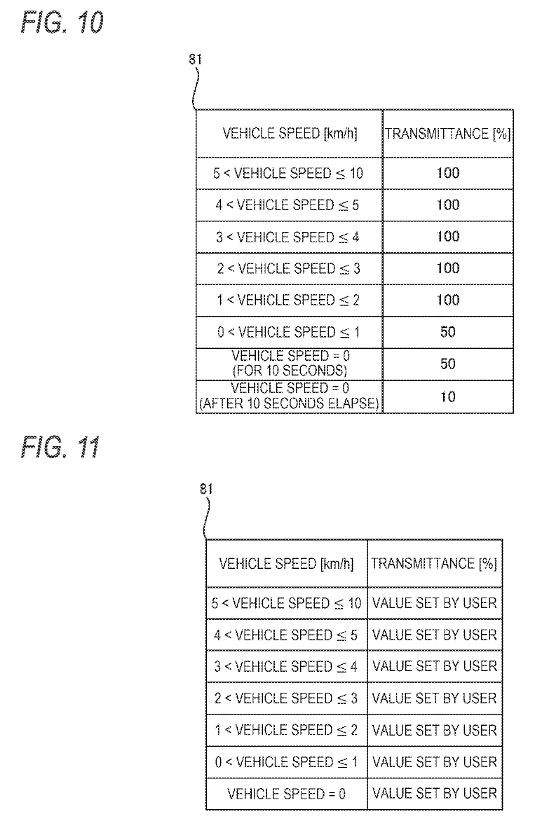

When the vehicle 1 is stopped, the display control unit 32 performs control to maintain the visibility of the portion corresponding to the blind spot image immediately before the stop for a predetermined time and change the visibility, after the predetermined time, to visibility corresponding to the stop of the vehicle 1. The "visibility corresponding to the stop of the vehicle 1" is visibility corresponding to a vehicle speed of 0 km/h. The maintenance of the visibility will be described later with reference to FIG. 10.

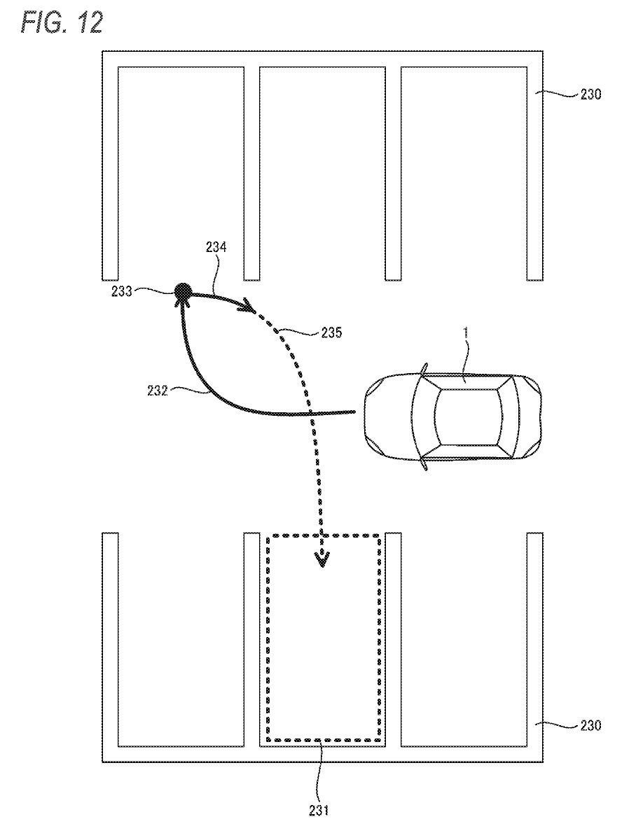

The display control unit 32 performs control to change the visibility of the portion corresponding to the blind spot image based on the vehicle speed using association information between the vehicle speed and a parameter of the visibility of the blind spot image. The association information can be set by the user. The "parameter of the visibility" is, for example, the transmittance of the mask image. The setting of the association information will be described later with reference to FIG. 11.

The display control unit 32 performs control to hide the portion corresponding to the blind spot image in the composite image when a contrast in the blind spot image is in a predetermined state. The "predetermined state" is a state where the contrast (light amount difference) is large. The "predetermined state" is, for example, a state where, when the blind spot image is divided into a plurality of blocks and an average luminance of the respective blocks is obtained, a difference between a maximum value and a minimum value of the average luminance is equal to or greater than a predetermined value. The contrast in the predetermined state will be described later with reference to FIG. 14.

### 3. Image on Display

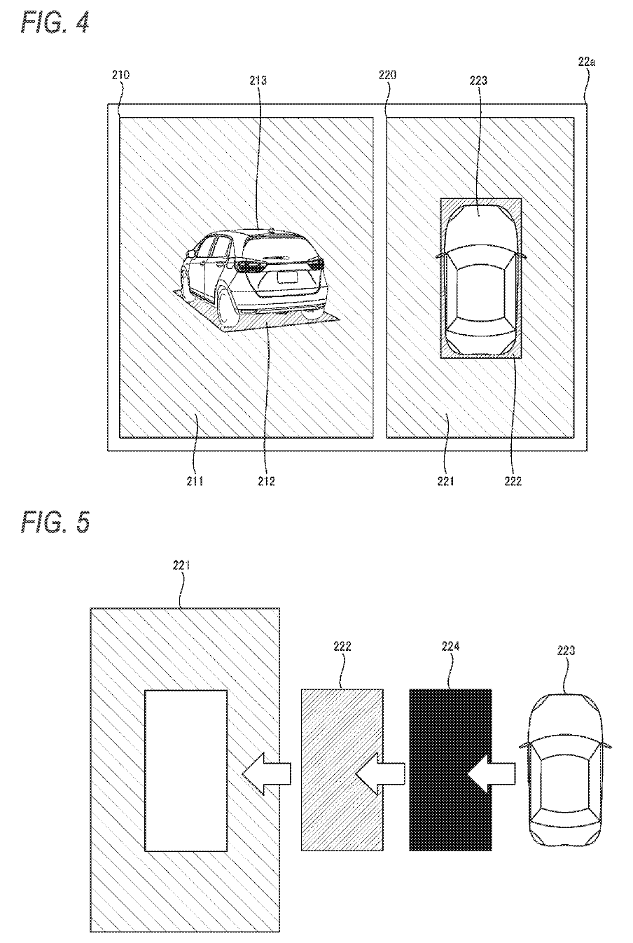

FIG. 4 is a diagram showing an example of an image displayed on the touch panel 22 of the vehicle 1. As shown in FIG. 4, a composite image generated from a 3D image 210 and a composite image generated from an overhead image 220 are displayed on a display screen 22a of the touch panel 22. The 3D image 210 and the overhead image 220 are displayed when the user performs an operation to instruct the display of the composite image during a manual driving operation or when the automatic parking is started during the automatic parking.

In the 3D image 210, a peripheral image 211 showing the periphery of the vehicle 1, a blind spot image 212 showing the area under the vehicle 1 (underfloor), and a vehicle image 213 showing the vehicle 1 are displayed in a superimposed manner. The 3D image 210 is an image obtained by performing image processing for three-dimensionally reconstructing a composite image of the imaging data acquired by the front camera 111a, the rear camera 111b, and the left and right side cameras 111c and virtually showing a state where the vehicle 1 and the periphery of the vehicle 1 are rotated and viewed from, for example, a lateral side or an obliquely upper side. The 3D image 210 shown in FIG. 4 is a 3D image viewed from a left rear of the vehicle 1. An orientation of the vehicle 1 in the 3D image 210 can be changed by, for example, a button operation.

In the overhead image 220, a peripheral image 221 showing the periphery of the vehicle 1, a blind spot image 222 showing the area under the vehicle 1 (underfloor), and a vehicle image 223 showing the vehicle 1 are displayed. The overhead image 220 is an image showing the vehicle 1 and the periphery of the vehicle 1 when the composite image of the imaging data acquired by the front camera 111a, the rear camera 111b, and the left and right side cameras 111c is viewed from above the vehicle 1. The vehicle images 213 and 223 are images each showing a state where the vehicle 1 is viewed from above, and are images generated (captured) in advance and stored in the storage unit 35 or the like. In the present example, the vehicle images 213 and 223 are displayed as non-transparent images, but are not limited thereto. For example, the vehicle images 213 and 223 may be displayed as transparent images. When the vehicle images 213 and 223 are displayed as transparent images, entire region of each of the blind spot images 212 and 222 is displayed to be visible.

### 4. Generation of Composite Image

FIG. 5 is a diagram showing an example of the composite image. As shown in FIG. 5, in the present example, a case of generating the composite image of the overhead image 220 will be described. In the present example, a mask image 224 is used to change visibility of the blind spot image 222 in the composite image. That is, the visibility of the blind spot image 222 is changed by changing the transmittance of the mask image 224.

As shown in FIG. 5, when generating the composite image, the peripheral image 221 of the vehicle 1 is placed at the bottom, and the blind spot image 222 is superimposed on a region of the vehicle 1 in the peripheral image 221. Next, the mask image 224 is superimposed on the blind spot image 222, and the vehicle image 223 is superimposed on the mask image 224. Then, the visibility of the blind spot image 222 is changed by setting transmittance of the mask image 224 and changing the transmittance of the mask image 224 according to the travel speed of the vehicle 1. When the blind spot image 222 is superimposed on the peripheral image 221, a vicinity of a boundary between the peripheral image 221 and the blind spot image 222 is appropriately blended.

A method of changing the visibility of the blind spot image 222 is not limited to the example of superimposing the mask image 224. For example, the visibility of the blind spot image 222 may be changed by changing the transmittance of the blind spot image 222 without superimposing the mask image 224, or the visibility of the blind spot image 222 may be changed by changing a degree of the mosaic processing/the blurring processing of the blind spot image 222.

### 5. Display Process of Composite Image Performed by Control Device

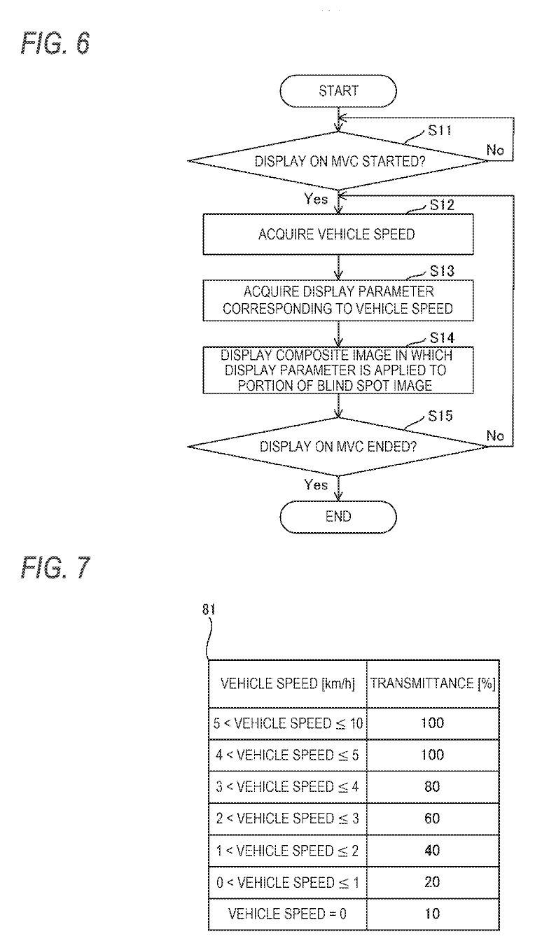

FIG. 6 is a flowchart showing an example of a display process of the composite image performed by the control device 30.

First, the control device 30 determines whether display on an MVC (multi-view camera) is started in the vehicle 1 (step S11). For example, the control device 30 determines whether the 3D image 210 and the overhead image 220 shown in FIG. 4 are displayed on the touch panel 22.

In step S11, if the display on the MVC is not started (step S11: No), the control device 30 repeats the processing in step S11. In step S11, if the display on the MVC is started (step S11: Yes), the control device 30 acquires the travel speed of the vehicle 1 (step S12).

Next, the control device 30 acquires a display parameter corresponding to the vehicle speed acquired in step S12 (step S13). The display parameter is, for example, the transmittance of the mask image 224. Examples of the display parameter will be described later with reference to FIGS. 7 to 11.

The control device 30 displays, on an image of the MVC, a composite image obtained by applying the display parameter acquired in step S13 to the portion corresponding to the blind spot image (step S14). For example, the control device 30 displays a composite image in which the transmittance of the mask image corresponding to the vehicle speed is applied to a portion corresponding to the blind spot image 212 in the 3D image 210 and a portion corresponding to the blind spot image 222 in the overhead image 220 shown in FIG. 4.

Next, the control device 30 determines whether the display on the MVC is ended in the vehicle 1 (step S15). In step S15, if the display on the MVC is not ended (step S15: No), the control device 30 returns to step S12 and performs the processing of each step. In step S15, if the display on the MVC is ended (step S15: Yes), the control device 30 ends the present process.

### 6. Association Information

Next, the association information between the travel speed of the vehicle 1 and the parameter of the visibility of the blind spot image will be described with reference to FIGS. 7 to 11. In the foregoing description of the exemplary embodiments, the transmittance of the mask image to be superimposed on the blind spot image is used as the display parameter for changing the visibility of the blind spot image.

### 6-1. First Example of Association Information

FIG. 7 shows a first example of the association information. As shown in FIG. 7, association information 81 associates the vehicle speed (km/h) of the vehicle 1 with the transmittance (%) of the mask image. In the association information 81, the vehicle speed and the transmittance are associated in a way that the transmittance of the mask image decreases as the vehicle speed of the vehicle 1 decreases.

Specifically, the association is such that when the vehicle speed (km/h) is, for example, 5 < vehicle speed ≤ 10 or 4 < vehicle speed ≤ 5, the transmittance of the mask image is 100 %. Further, the association is such that the transmittance of the mask image is 80 % when the vehicle speed (km/h) is 3 < vehicle speed ≤ 4, the transmittance of the mask image is 60 % when the vehicle speed (km/h) is 2 < vehicle speed ≤ 3, the transmittance of the mask image is 40 % when the vehicle speed (km/h) is 1 < vehicle speed ≤ 2, and the transmittance of the mask image is 20 % when the vehicle speed (km/h) is 0 < vehicle speed ≤ 1. Further, the association is such that when the vehicle speed is 0 km/h, the transmittance of the mask image is 10 %. Therefore, the visibility of the blind spot image decreases as the vehicle speed of the vehicle 1 decreases.

### 6-2. Second Example of Association Information

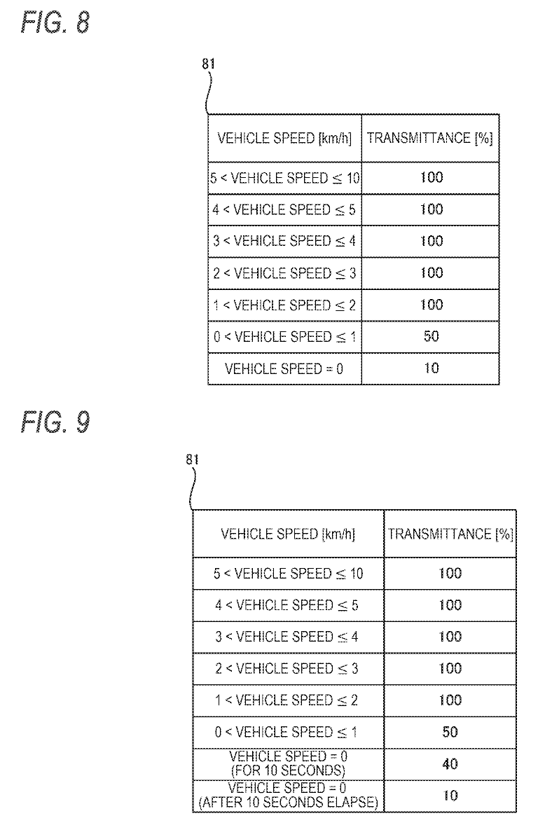

FIG. 8 shows a second example of the association information. As shown in FIG. 8, in the association information 81 in the second example, the vehicle speed and the transmittance are associated in a way that the transmittance of the mask image decreases as the vehicle speed of the vehicle 1 decreases, as in the first example. However, the transmittance of the mask image in the second example decreases differently than the transmittance of the mask image in the first example.

Specifically, the association is such that when the vehicle speed (km/h) is, for example, 5 < vehicle speed ≤ 10, 4 < vehicle speed ≤ 5, 3 < vehicle speed ≤ 4, 2 < vehicle speed ≤ 3, 1 < vehicle speed ≤ 2, the transmittance of the mask image is 100 %. Further, the association is such that when the vehicle speed (km/h) is 0 < vehicle speed ≤ 1, the transmittance of the mask image is 50 %. Further, the association is such that when the vehicle speed is 0 km/h, the transmittance of the mask image is 10 %. Accordingly, the visibility of the blind spot image decreases as the vehicle speed of the vehicle 1 decreases.

### 6-3. Third Example of Association Information

FIG. 9 shows a third example of the association information. As shown in FIG. 9, in the association information 81 in the third example, the vehicle speed and the transmittance are associated in a way that the transmittance of the mask image decreases as the vehicle speed of the vehicle 1 decreases, as in the second example. However, the transmittance of the mask image in the third example decreases differently, after the vehicle 1 is stopped, than the transmittance of the mask image in the second example.

Specifically, the association is such that when the vehicle speed (km/h) is, for example, 5 < vehicle speed ≤ 10, 4 < vehicle speed ≤ 5, 3 < vehicle speed ≤ 4, 2 < vehicle speed ≤ 3, 1 < vehicle speed ≤ 2, the transmittance of the mask image is 100 %. Further, the association is such that when the vehicle speed (km/h) is 0 < vehicle speed ≤ 1, the transmittance of the mask image is 50 %. Then, the association is such that when the vehicle speed is 0 km/h, the transmittance of the mask image decreases to 40 % for 10 seconds, and after the 10 seconds elapse, the transmittance of the mask image is 10 %. That is, in the third example, the association is such that the transmittance of the mask image decreases when the vehicle 1 is stopped, and the transmittance of the mask image is further decreased after a predetermined time elapses from the stop. Accordingly, the visibility of the blind spot image decreases as the vehicle speed of the vehicle 1 decreases.

### 6-4. Fourth Example of Association Information

FIG. 10 shows a fourth example of the association information. As shown in FIG. 10, in the association information 81 in the fourth example, the vehicle speed and the transmittance are associated in a way that the transmittance of the mask image decreases as the vehicle speed of the vehicle 1 decreases, as in the third example. However, the transmittance of the mask image in the fourth example decreases differently, when the vehicle 1 is stopped, than the transmittance of the mask image in the third example.

Specifically, the association is such that when the vehicle speed (km/h) is, for example, 5 < vehicle speed ≤ 10, 4 < vehicle speed ≤ 5, 3 < vehicle speed ≤ 4, 2 < vehicle speed ≤ 3, 1 < vehicle speed ≤ 2, the transmittance of the mask image is 100 %. Further, the association is such that when the vehicle speed (km/h) is 0 < vehicle speed ≤ 1, the transmittance of the mask image is 50 %. Then, the association is such that when the vehicle speed is 0 km/h, the transmittance of the mask image is maintained at 50 % for 10 seconds, and after the 10 seconds elapse, the transmittance of the mask image is 10 %. That is, in the fourth example, the association is such that when the vehicle 1 is stopped, the transmittance of the mask image is maintained at the transmittance immediately before the stop (when 0 < vehicle speed ≤ 1) for a predetermined time, and after the predetermined time elapses, the transmittance of the mask image decreases to the transmittance corresponding to the stop of the vehicle 1.

### 6-5. Fifth Example of Association Information

FIG. 11 shows a fifth example of the association information. As shown in FIG. 11, the association information 81 of the fifth example is configured to enable the user to set the transmittance (%) of the mask image with respect to the vehicle speed (km/h) of the vehicle 1.

Specifically, the vehicle speed (km/h) is divided into ranges, for example, 5 < vehicle speed ≤ 10, 4 < vehicle speed ≤ 5, 3 < vehicle speed ≤ 4, 2 < vehicle speed ≤ 3, 1 < vehicle speed ≤ 2, 0 < vehicle speed ≤ 1, and vehicle speed =0. The transmittance (%) of the mask image with respect to each vehicle speed can be set to any value by the user.

### 7. Display Control on Composite Image during Automatic Parking

FIG. 12 is a diagram illustrating an example of display control on the composite image when the vehicle 1 automatically parks to a target parking position 231. As shown in FIG. 12, a plurality of parking regions are partitioned by partition lines 230, and the vehicle 1 is about to automatically park to the target parking position 231 among the parking regions.

In this case, the vehicle 1 first advances toward the target parking position 231 on an advancing route 232 from the present location to a turning point 233 as indicated by an arrow. When reaching the turning point 233, the vehicle 1 temporarily stops, and switches the shift position of the shift lever from drive (D) to reverse (R). Next, the vehicle 1 reverses along a reversing route 234 and a reversing route 235 and travels to the target parking position 231.

In the automatic parking of the vehicle 1 based on such traveling, the control device 30 does not perform control to decrease the visibility of the blind spot image of the vehicle 1 based on the vehicle speed, while the vehicle 1 is traveling on the advancing route 232 from the present location to the turning point 233 and while the vehicle 1 reaches the turning point 233 and switches the shift position to travel on the reversing route 234 from the turning point 233 by a predetermined distance, that is, during a traveling period indicated by solid arrows in FIG. 12. For example, the control device 30 fixes the visibility of the blind spot image of the vehicle 1 to constant visibility (0 %) on the advancing route 232 and the reversing route 234 to make the blind spot image easy to see. When the control device 30 sets the display parameter as the mask image, the control device 30 fixes the transmittance of the mask image to 100 %. Then, when the vehicle 1 passes through the reversing route 234 and travels on the reversing route 235 (a route indicated by a dashed arrow), the control device 30 starts control to decrease the visibility of the blind spot image of the vehicle 1 based on the vehicle speed.

### 8. Composite Image for Each Transmittance of Mask Image

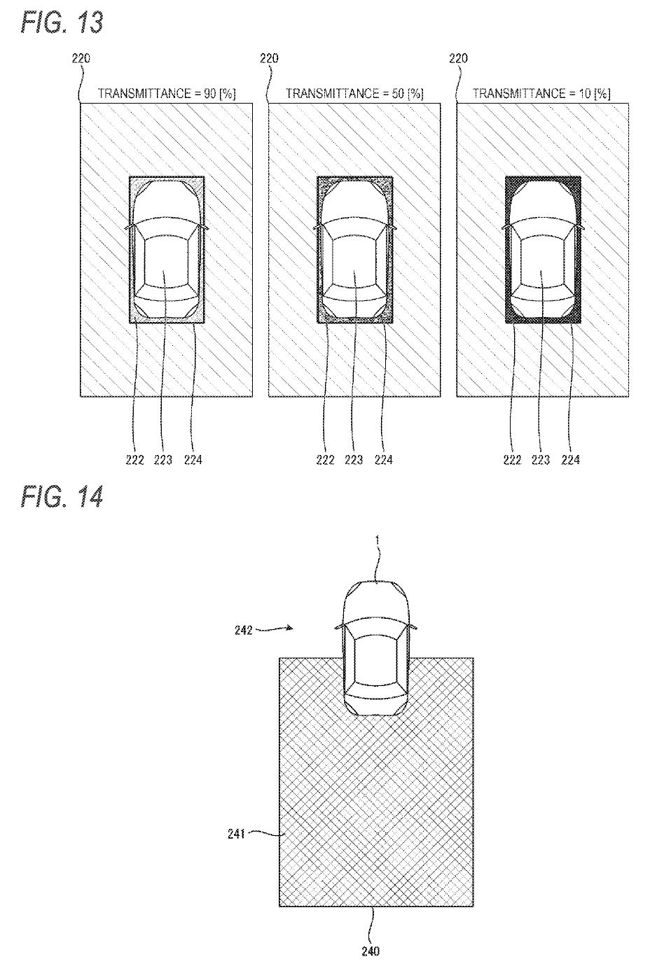

FIG. 13 is a diagram showing an example for a comparison of the composite image based on a difference in the transmittance of the mask image 224. The example of FIG. 13 shows a comparison of composite images where the transmittance of the mask image 224 is 90 %, another where the transmittance is 50 %, and another where the transmittance is 10 %. In the example of FIG. 13, a comparison of the composite image in the overhead image 220 is shown.

As shown in FIG. 13, as the transmittance of the mask image 224 decreases, the visibility of the portion of the blind spot image 222 in the composite image decreases. That is, the lower the transmittance of the mask image 224, the more difficult it is to visually recognize the blind spot image 222. Specifically, the visibility of the portion of the blind spot image 222 when the transmittance of the mask image 224 is 50 % is lower than the visibility of the portion of the blind spot image 222 when the transmittance of the mask image 224 is 90 %. Further, the visibility of the portion of the blind spot image 222 when the transmittance of the mask image 224 is 10 % is lower than the visibility of the portion of the blind spot image 222 when the transmittance of the mask image 224 is 50 %.

### 9. Blind Spot Image Including Region Having Contrast

FIG. 14 is a diagram showing an example of a state where the blind spot image of the vehicle 1 includes a region having a contrast. The example of FIG. 14 shows a state where the vehicle 1 is about to enter a garage 240 by reversing. A rear portion of the vehicle 1 is located inside the garage 240, and a front portion of the vehicle 1 is located outside the garage 240 (outdoors). The garage 240 is a dark region 241 in which a light amount is small, and the outdoors is a bright region 242 in which the light amount is large.

As shown in FIG. 14, in a state where the vehicle 1 is located across two regions (the dark region 241 and the bright region 242) having a large contrast, when the 3D image 210 or the overhead image 220 is about to be displayed on the touch panel 22 (for example, see FIG. 4), a region having a large contrast is also generated in the blind spot image of the vehicle 1. Therefore, when the region having a large contrast is generated in the blind spot image of the vehicle 1, the control device 30 performs control to hide the portion corresponding to the blind spot image in the composite image. For example, the control device 30 divides the region of the blind spot image of the vehicle 1 into a plurality of blocks, obtains an average luminance for each block, and hides the blind spot image when a difference between a maximum value and a minimum value of the average luminance is a predetermined value or more.

As described above, the control device 30 decreases the visibility of the portion corresponding to the blind spot image in the composite image as the travel speed of the vehicle 1 decreases, and displays the portion corresponding to the blind spot image in the composite image even when the vehicle 1 is in the stopped state. According to the configuration, it is possible to prevent discomfort caused by a deviation of the blind spot image from a real image (the blind spot image having a time lag) due to an increase in recognizability of the user for the image as the speed decreases. Further, since the blind spot image in the composite image is displayed even when the vehicle 1 is in the stopped state, it is possible to prevent discomfort caused by the blind spot image disappearing unexpectedly, for example, during parking of the vehicle 1. Accordingly, it is possible to improve a display performance of the region that is the blind spot in the 3D image or the overhead image of the vehicle 1.

In a case where the vehicle 1 automatically parks from the present location to the target parking position 231, when the turning point 233 is present on a route to the target parking position 231, the control device 30 prevents the control for changing the visibility of the portion corresponding to the blind spot image based on the vehicle speed while the vehicle 1 is passing through the turning point 233 and traveling by a predetermined distance. According to the configuration, since the visibility of the blind spot image is changed according to the vehicle speed at a stage of approaching the target parking position 231 after passing through the turning point 233, the blind spot image in the composite image can be displayed as an image with less sense of discomfort on the route close to the target parking position 231. Accordingly, it is possible to improve the display performance of the region that is the blind spot of the vehicle 1.

When the vehicle 1 is stopped, the control device 30 maintains the visibility immediately before the stop, which is slightly higher than the visibility of the blind spot image corresponding to the stop, for a predetermined time, and changes the visibility of the blind spot image to the visibility corresponding to the stop of the vehicle 1 (vehicle speed = 0 km/h) after the predetermined time elapses. According to the configuration, since the blind spot region can be easily recognized for a predetermined period immediately after the vehicle 1 is stopped, it is possible to prevent discomfort of the user that the blind spot image is difficult to see when the vehicle stops. Accordingly, it is possible to improve the display performance of the blind spot region in the composite image.

When the blind spot image of the composite image includes a region having a large contrast due to a difference in the light amount, the control device 30 hides the portion corresponding to the blind spot image in the composite image. According to the configuration, it is possible to reduce difficulty in recognizing the composite image caused by the mixture of the bright region and the dark region in the blind spot image, and to improve the display performance of the blind spot region in the composite image.

According to the control device 30, since the user can set the parameter of the visibility of the blind spot image corresponding to the vehicle speed, it is possible to adjust the visibility of the blind spot image suitable for each user. Accordingly, it is possible to improve the display performance of the blind spot region in the composite image.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present invention is not limited thereto. For example, the computer that executes the present program may be provided in another device (for example, the external device 2) capable of communicating with the control device 30.

In the embodiment described above, a case where the display control unit 32 displays the overhead image and the 3D image on the touch panel 22 of the vehicle 1 has been described, but the present invention is not limited thereto. For example, the display control unit 32 may display the overhead image and the 3D image on a display screen of an information terminal (for example, a smartphone) carried by a passenger of the vehicle 1 via the communication unit 70.

In the present description, at least the following matters are described. In the parentheses, the corresponding constituent elements and the like in the above embodiment are shown as examples, but the present invention is not limited thereto.
(1) A control device (control device 30) including a processor (imaging control unit 31, display control unit 32) configured to
acquire a captured image using an imaging device (front camera 111a, rear camera 111b, and side cameras 111c) provided in a vehicle (vehicle 1), and
display a composite image of a current peripheral image of the vehicle (peripheral image 211 , 221) and a blind spot image of the vehicle (blind spot image 212, 222) on a display (touch panel 22), the current peripheral image being based on the captured image acquired by the processor, the blind spot image being based on the captured image acquired by the processor in the past, in which
the processor is further configured to
   perform control to change visibility of a portion corresponding to the blind spot image in the composite image based on a vehicle speed of the vehicle, and
   display the portion corresponding to the blind spot image in the composite image even when the vehicle is in a stopped state.

According to (1), by changing the visibility of the portion corresponding to the blind spot image in the composite image according to a travel speed of the vehicle, it is possible to prevent discomfort caused by a change in an image recognition degree due to a speed difference. Furthermore, by displaying the portion corresponding to the blind spot image in the composite image even when the vehicle is in the stopped state, it is possible to prevent discomfort caused by the blind spot image disappearing unexpectedly. Accordingly, it is possible to improve a display performance of a region that is the blind spot of the vehicle.

(2) The control device according to (1), in which the processor is further configured to decrease the visibility of the portion corresponding to the blind spot image in the composite image as the vehicle speed decreases.

According to (2), by decreasing the visibility of the portion corresponding to the blind spot image in the composite image as the vehicle speed decreases, it is possible to prevent discomfort caused by a deviation of the blind spot image from a real image (the blind spot image having a time lag) due to an increase in recognizability of the user for the image as the speed decreases.

(3) The control device according to (1) or (2), in which, the processor is further configured to display the composite image on the display and changes the visibility based on the vehicle speed when an instruction operation for displaying the composite image from a user is received while the vehicle is moved by a driving operation of the user.

As in (3), when the user performs the driving operation on the vehicle, it is preferable to display the composite image in which the visibility of the blind spot image changes on the display unit according to the instruction of the user.

(4) The control device according to any of (1) to (3), in which the processor (parking control unit 34) is configured to perform automatic parking, enabling the vehicle to move automatically from a present location to a target parking position, and
the processor is further configured to display the composite image on the display and changes the visibility based on the vehicle speed when the automatic parking is started by the processor.

As in (4), during the automatic parking of the vehicle, it is preferable to display, on the display unit, the composite image in which the visibility of the blind spot image changes, as the automatic parking starts.

(5) The control device according to (4), in which when a route from the present location to the target parking position includes a turning point,
the processor is further configured to prevent the control for changing the visibility based on the vehicle speed, until the vehicle passes the turning point and performs a predetermined travel.

As in (5), it is preferable to perform the control to change the visibility of the blind spot image on a route that passes through the turning point and approaches the target parking position.

(6) The control device according to any of (1) to (5), in which the processor is further configured to hide the portion corresponding to the blind spot image in the composite image when a shift state of the vehicle is parking.

As in (6), it is preferable to hide the portion corresponding to the blind spot image in the composite image when the shift state of the vehicle is parking and the vehicle is stopped.

(7) The control device according to any of (1) to (5), in which t the processor is further configured to replace the portion corresponding to the blind spot image in the composite image with a predetermined image when a shift state of the vehicle is parking.

As in (7), it is preferable to replace the portion corresponding to the blind spot image in the composite image with a predetermined image when the shift state of the vehicle is parking and the vehicle is stopped.

(8) The control device according to any of (1) to (7), in which when the vehicle is stopped
the processor is further configured to maintain the visibility immediately before the vehicle stops for a predetermined time, and
change the visibility to visibility corresponding to the stopped state of the vehicle after the predetermined time elapses.

According to (8), when the vehicle is stopped, the visibility immediately before the stop, which is slightly higher than the visibility of the blind spot image corresponding to the stop, is maintained for a predetermined time, thus the blind spot region of the vehicle immediately after the stop can be easily recognized, and the display performance of the blind spot region can be improved.

(9) The control device according to any of (1) to (8), in which the processor is further configured to use association information between the vehicle speed and a parameter of the visibility of the blind spot image to change the visibility based on the vehicle speed, and
the association information can be set by a user.

According to (9), the user can set the parameter of the visibility of the blind spot image corresponding to the vehicle speed, so that the visibility of the blind spot image can be adjusted to the visibility suitable for the user, and the display performance of the blind spot region can be improved.

(10) The control device according to any of (1) to (9), in which the processor is further configured to hide the portion corresponding to the blind spot image in the composite image when a contrast in the blind spot image is in a predetermined state.

As in (10), by hiding the portion corresponding to the blind spot image in the composite image when the contrast in the blind spot image of the vehicle is in a predetermined state, the blind spot image can be prevented from becoming an image that is difficult to recognize, and the display performance of the blind spot region can be improved.

(11) A control method for a control device including a processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past,
the control method including:
performing control to change visibility of a portion corresponding to the blind spot image in the composite image based on a vehicle speed of the vehicle; and
displaying the portion corresponding to the blind spot image in the composite image even when the vehicle is in a stopped state.

According to (11), by changing the visibility of the portion corresponding to the blind spot image in the composite image according to the travel speed of the vehicle, it is possible to prevent discomfort caused by a change in an image recognition degree due to a speed difference. Furthermore, by displaying the portion corresponding to the blind spot image in the composite image even when the vehicle is in the stopped state, it is possible to prevent discomfort caused by the blind spot image disappearing unexpectedly. Accordingly, it is possible to improve a display performance of a region that is the blind spot of the vehicle.

(12) A non-transitory computer-readable storage medium storing a control program causing a processor of a control device to perform processing, the processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past,
the processing including:
   performing control to change visibility of a portion corresponding to the blind spot image in the composite image based on a vehicle speed of the vehicle; and
   displaying the portion corresponding to the blind spot image in the composite image even when the vehicle is in a stopped state.

According to (12), by changing the visibility of the portion corresponding to the blind spot image in the composite image according to the travel speed of the vehicle, it is possible to prevent discomfort caused by a change in an image recognition degree due to a speed difference. Furthermore, by displaying the portion corresponding to the blind spot image in the composite image even when the vehicle is in the stopped state, it is possible to prevent discomfort caused by the blind spot image disappearing unexpectedly. Accordingly, it is possible to improve the display performance of the region that is the blind spot of the vehicle.

What is claimed is:

1. A control device comprising a processor configured to
acquire a captured image using an imaging device provided in a vehicle, and
display a composite image of a current peripheral image of the vehicle and a blind spot image of the vehicle on a display, the current peripheral image being based on the captured image acquired by the processor, the blind spot image being based on the captured image acquired by the processor in the past, wherein
the processor is further configured to
perform control to change visibility of a portion corresponding to the blind spot image in the composite image based on a vehicle speed of the vehicle, and
display the portion corresponding to the blind spot image in the composite image even when the vehicle is in a stopped state.

2. The control device according to claim 1, wherein
the processor is further configured to decrease the visibility of the portion corresponding to the blind spot image in the composite image as the vehicle speed decreases.

3. The control device according to claim 1, wherein
the processor is further configured to display the composite image on the display and changes the visibility based on the vehicle speed when an instruction operation for displaying the composite image from a user is received while the vehicle is moved by a driving operation of the user.

4. The control device according to claim 1, wherein
the processor is configured to perform automatic parking, enabling the vehicle to move automatically from a present location to a target parking position, and
the processor is further configured to display the composite image on the display and changes the visibility based on the vehicle speed when the automatic parking is started by the processor.

5. The control device according to claim 4, wherein
when a route from the present location to the target parking position includes a turning point,
the processor is further configured to prevent the control for changing the visibility based on the vehicle speed, until the vehicle passes the turning point and performs a predetermined travel.

6. The control device according to claim 1, wherein
the processor is further configured to hide the portion corresponding to the blind spot image in the composite image when a shift state of the vehicle is parking.

7. The control device according to claim 1, wherein
the processor is further configured to replace the portion corresponding to the blind spot image in the composite image with a predetermined image when a shift state of the vehicle is parking.

8. The control device according to claim 1, wherein
when the vehicle is stopped
the processor is further configured to maintain the visibility immediately before the vehicle stops for a predetermined time, and
change the visibility to visibility corresponding to the stopped state of the vehicle after the predetermined time elapses.

9. The control device according to claim 1, wherein
the processor is further configured to use association information between the vehicle speed and a parameter of the visibility of the blind spot image to change the visibility based on the vehicle speed, and
the association information can be set by a user.

10. The control device according to claim 1, wherein
the processor is further configured to hide the portion corresponding to the blind spot image in the composite image when a contrast in the blind spot image is in a predetermined state.

11. A control method for a control device including a processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past,
the control method comprising:
performing control to change visibility of a portion corresponding to the blind spot image in the composite image based on a vehicle speed of the vehicle; and
displaying the portion corresponding to the blind spot image in the composite image even when the vehicle is in a stopped state.

12. A non-transitory computer-readable storage medium storing a control program causing a processor of a control device to perform processing, the processor configured to acquire a captured image using an imaging device provided in a vehicle, and display a composite image of a current peripheral image of the vehicle and a blind spot image of the vehicle on a display, the current peripheral image being based on the captured image acquired by the processor, the blind spot image being based on the captured image acquired by the processor in the past,
the processing comprising:
performing control to change visibility of a portion corresponding to the blind spot image in the composite image based on a vehicle speed of the vehicle; and
displaying the portion corresponding to the blind spot image in the composite image even when the vehicle is in a stopped state.
